(19) United States
(12) Patent Application Publication
(10) Pub. No.: US 2008/0226069 A1
(43) Pub. Date: Sep. 18, 2008

(54) Apparatus and Method for Providing Protection from Malware

(75) Inventor: Teewoon Tan, Roseville (AU)

Correspondence Address: MICHAEL MOLINS;MOLINS & CO., SUITE 5, LEVEL 6, 139 MACQUARIE ST, SYDNEY NSW, 2000, AU

(73) Assignee: Encrypted Shields Pty Ltd, Pyrmont (AU)

(21) Appl. No.: 12/046,447

(22) Filed: Mar. 12, 2008

(30) Foreign Application Priority Data
Mar. 14, 2007 (AU) 2007901297

(51) Int. Cl. H04L 9/00; G06F 12/14

(52) U.S. Cl. 380/255; 713/189

(57) ABSTRACT

An apparatus for protecting against malware comprises a first and a second processing module. The first processing module encrypts an input data generated by an input device. The encryption reduces unauthorized data monitoring by spyware. The second processing module is attached to the front of a protected data destination. The second processing module performs a decryption on any data that originates from the input device and enters the data destination. The encryption and decryption are synchronized. The decryption reduces the risk posed by an unencrypted backdoor command by making it undecipherable.

### FIELD OF THE INVENTION

This invention relates to anti-malware technologies and the like, more particularly, anti-malware technologies for preventing unauthorised data appropriation from or unauthorised control of computer systems

### BACKGROUND OF THE INVENTION

Malware is generally defined as malicious software intended to damage, degrade, or infiltrate a computer without the owner's consent.

In a computer system, an input data generated by an input source is sent to a data destination. “Spyware” is a malware designed for an attacker to secretly record input data on a computer system. A “backdoor” is a malware designed to provide an attacker remote access to a computer system. Via the backdoor, the attacker can execute commands on the computer, or control the computer to some degree. It is possible that an attacker has full control of the computer via the backdoor.

Standard anti-virus and anti-spyware solutions rely on signatures to detect the presence of, or the operational behaviour of, malware. These techniques require reliable signatures of the malware. These techniques do not always detect a malware for which an effective signature is not available.

There are different types of data destinations, such as a word processing application or a web browser application. Some anti-spyware solutions require the source code of some applications to be modified. This requirement is impractical, and is the reason why these anti-spyware solutions are not available for all applications. These anti-spyware solutions are typically only available for applications that are extensible through the use of plug-ins or add-ons. However, not all applications support the use of plug-ins or add-ons.

Furthermore, not all plug-ins and add-ons operate in the same way. Therefore to incorporate some anti-spyware solutions, developers have to learn about each relevant plug-in/add-on architecture and application programming interfaces (APIs), and tailor the solutions accordingly. Anti-spyware solutions that protect input data from spyware will also require plug-in/add-on architectures that support the processing of input data. Not all plug-in/add-on architectures support the processing of input data.

Examples of data destinations that support plug-ins/add-ons include the Microsoft Internet Explorer web browser, Mozilla Firefox web browser, and Microsoft Office applications. Examples of data destinations that do not support plug-ins/add-ons include Microsoft Notepad, Microsoft Wordpad, Microsoft Windows command shell (“cmd.exe”), some Telnet applications, some file transfer protocol (FTP) applications, some text editing applications, and some applications that require a computer user to input sensitive data such as passwords and credit card details.

### OBJECTS AND SUMMARY OF THE INVENTION

It is an object of the present technology to provide a system and method for protecting input data from malware applications during its delivery to a data destination.

It is another object of the present technology to provide an anti-malware solution that does not require a malware signature.

It is another object of the present technology to provide protected input data to different data destinations without modifying the source codes of the data destinations even when the data destinations are not designed to be extensible such as through the use of plug-ins or add-ons.

Accordingly, there is provided a computer readable medium having stored therein computer programs, comprising a first processing module for performing an encryption on an input data from an input device, a second processing module comprising internal functions that are attachable to a data destination, the internal functions adapted to intercept a data for the data destination and perform a decryption.

There is also provided an apparatus that mitigates against a malware attack, comprising a first processing module installed on a computer having an input device, the input device generating an input data, the first processing module performing an encryption on the input data, a second processing module for performing a decryption, the second processing module being adapted to intercept and decrypt a data being transmitted to a data destination.

There is further provided a method of protecting a computer against malware, comprising the steps of installing into a memory of the computer, a first processing module and enabling the first processing module to receive an input data from an input device, employing a data encryption within the first processing module, registering the first processing module to receive a signal from an operation system that generates a data destination, recording a data destination information when the signal is received, employing a data decryption within a second processing module, and attaching the second processing module to a front of the data destination.

### BRIEF DESCRIPTION OF THE DRAWINGS FIGURES

In order that the invention be better understood, reference is now made to the following drawing figures in which:

FIG. 1 is a schematic diagram depicting an overview of a security system in accordance with the present technology;

FIG. 2 depicts a flowchart outlining the steps involved in protecting a data destination in one embodiment of the present invention;

FIG. 3 is a schematic diagram depicting an attachment between a second processing module and a data destination;

FIG. 4 is a flowchart depicting an operation of the security system;

FIG. 5 is a flowchart depicting a transmission process of an initialisation data;

FIG. 6 is a flowchart depicting a process for switching between different data destinations;

FIG. 7 depicts a schematic view of one embodiment of the present invention;

FIG. 8 depicts a schematic view of the data flow of one embodiment of the present invention;

FIG. 9 depicts a schematic view of the data flow of one embodiment of the present invention that includes a controller module; and

FIG. 10 is a schematic diagram depicting a networked embodiment of the security system.

### BEST MODE AND OTHER EMBODIMENTS

### Definitions

Throughout the specification, “input data” refers to data generated by an input source. The input source is a hardware such as a keyboard, a mouse, or another input device. The data is generated through the interaction between an “actor” (i.e. a user or an external system) and the input device. The input device converts the interactions into input data that can be further processed by the computer system. Within the system the input data is delivered to a data destination. A data destination normally has at least one input handling function designed to receive and process input data.

A “data destination” is a running application, window, process or thread that has the ability to receive the input data. Examples of data destinations include running instances of the following: a web browser application, a word processor application, a spreadsheet application, an e-mail client application, a command line shell application, such as “cmd.exe” (WINDOWS™) or “/bin/sh” (Linux), a secure shell (SSH) client application, a telnet application, a file transfer protocol (FTP) client application, a server or client application, a stand-alone or networked application, a graphics application, a multimedia-type application, a presentation-type application, a note-taking software application, a source code editing application, a password management application, a games application, a text editing application, an application having the ability to receive input data, or other custom applications.

The source code for a data destination may be, for example, a code written in a high level language that is compiled to machine code. Examples of such a language are C, C++ and Python. The source code may alternatively be written in a high level language that is compiled to an intermediate form that is then executed by a virtual execution system/machine. An example of such a language is C#, where source code written in C# is compiled to the Intermediate Language (IL), which is then compiled “just-in-time” into a form that can be executed by the underlying computer hardware. Another example of a high level language in this category is Java. The source code may alternatively be written in an interpreted language, such as Python. Alternatively, the source code may be written in a scripting language, such as JavaScript or VBScript.

A data destination that is protected by the present technology is referred to as a “protected data destination”. The process of providing protected input data to a data destination is also herein referred to as protecting the data destination. The present technology can protect a data destination without requiring modifications to the source code of the data destination or the use of plug-ins/add-ons.

### Overview

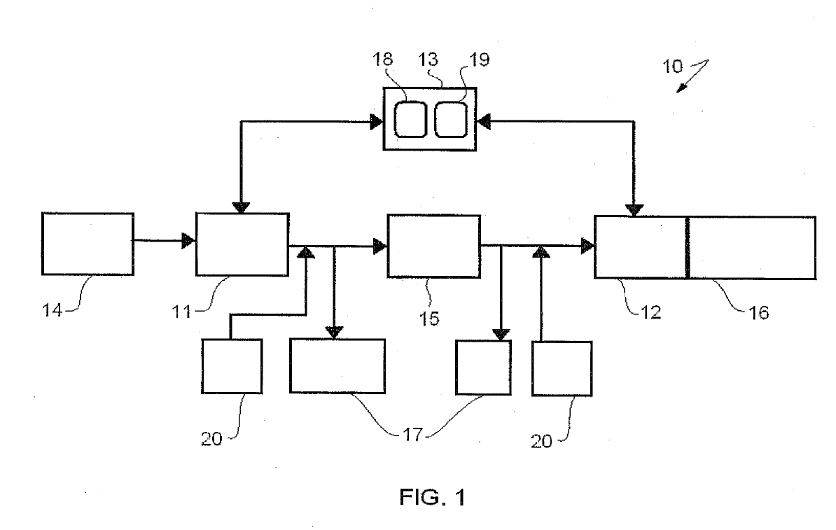

Referring to FIG. 1, a security system 10 in accordance with the present technology mitigates the risk of malware attack upon a computer or a computer system. The security system 10 comprises a first processing module 11 for encrypting data, and one or more second processing modules 12 for decrypting data. In some embodiments, the first processing modules 11 are device drivers, and the second processing modules reside in the user space, where the data destinations are executed. In these embodiments, spyware applications typically record data at some point between the first processing module and the second processing module. Therefore, by encrypting the input data at the first processing module and decrypting at the second processing module, the data that a spyware application obtains is encrypted. The risk of a malicious attacker comprehending the data obtained via a spyware application is thus mitigated.

An optional “control module” (or “controller”) 13 may also be used that controls the operation of the first and second processing modules. The optional controller 13 may be separate to the first and second processing modules. Alternatively, the tasks performed by the controller 13 may be performed by internal functions of the second processing module.

The first processing module receives and encrypts input data from an input device 14. In this example, the first processing module is akin to a device driver for the input device 14. The encryption process mitigates the risk of a malicious attacker comprehending the data obtained via a spyware application. Preferably the first processing module 11 encrypts the input data as early as possible, with little or no processing done to the input data before the data reaches the first processing module 11. The encrypted data is processed and propagated by the operating system 15 to various data destinations 16 through the same communications channels that would be used for unencrypted data. A spyware application 17 monitoring these channels would observe the encrypted data.

Each second processing module 12 intercepts the encrypted input data before it is propagated to a data destination 16. It then decrypts the encrypted input data. The second processing module 12 provides the extracted input data to the data destination 16. The data destination 16 is attached to the second processing module. Preferably this is done late in the processing chain. For example the second processing modules 12 may be implemented in the user space, at a level where the data destinations are executed. Any unauthorised command, issued by a backdoor application 20, would be subjected to the decryption mechanism before reaching the data destination 16.

It is further preferred that the second processing module automatically attaches to a data destination without requiring a change in the source code of the data destination 16. Therefore, in the preferred embodiments, the security system 10 encrypts and decrypts data without adding plug-ins into or changing the source code of the data destination 16.

The source code refers to data destination codes written in a high level language that can be compiled into machine code or into an intermediate code executable by the computer hardware. The source code may also be codes written an interpretable language such as Python, or codes written in a scripting language such as JavaScript or VBScript. The source code does not refer to the machine instructions of the data destination.

In some embodiments, the second processing module is implemented and installed in a computer system as an executable file, or as a library such as a dynamic link library (DLL). In some examples the second processing module comprises an executable file and a library. At any time, there is one running instance of the first processing module, and there may be zero or more running instances of the second processing module. Each second processing module 12 is attached onto one protected data destination 16.

The controller 13 may further comprise an optional user interface 18. The user interface 18 may be programmed to provide a user with functions such as disabling or restarting data encryption and decryption. In embodiments where the encryption and decryption mechanisms operate according to the same sequence of random keys or according to stream ciphers, the user interface 18 may further allow users the option of re-synchronising data encryption and decryption.

The controller 13 may further comprise a database 19 that includes information regarding the different types of processes that may run, given the current operating system. For example, the database comprises the identifiers of the data destinations that are protected by the security system 10. The database may also comprises the names of the input handling functions used by each type of data destination, the starting memory address of the input handling functions, and the libraries used by the input handling functions. The second processing module 12 may be attached to the data destination via one or more machine instructions. The machine instructions are generated according to the information comprised in this database.

### Protecting a Data Destination

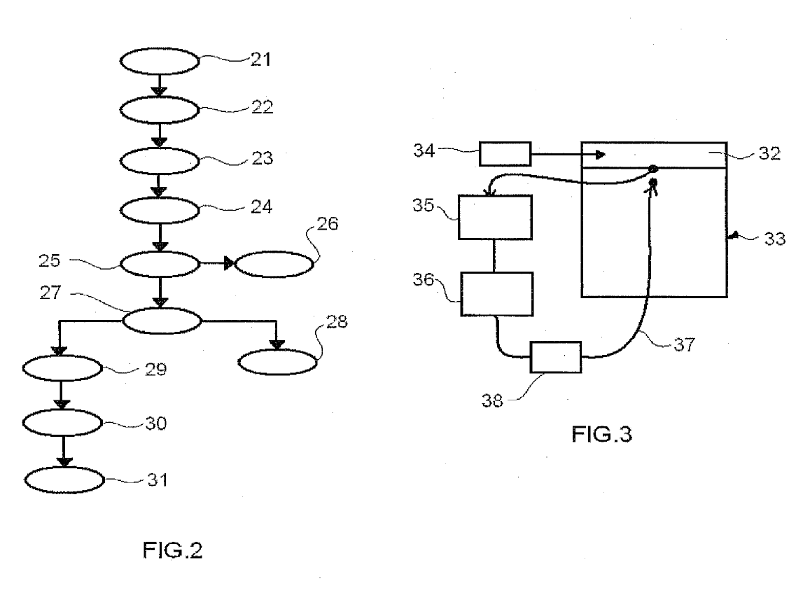

FIG. 2 depicts the process that “protects” a data destination. After a data destination becomes protected, all input data sent from the input device to the protected data destination is encrypted. Malicious attackers cannot easily comprehend data obtained via spyware applications, because the data is encrypted.

As shown in FIG. 2, the first processing module is installed into the computer system 21. To be effective, the first processing module is preferably installed after the point where input data is generated. The first processing module may be a driver for the input device. For example, the first processing module may be a keyboard filter device driver that encrypts input keystrokes as they are received from the keyboard.

The first processing module is registered with the operating system 22, so that the first processing module receives a signal when the operating system creates a new data destination. In one embodiment, registration is done by calling an operating system procedure. An operating system procedure then calls or invokes an internal function of the first processing module whenever a new data destination is created.

For example, the Microsoft Windows operating system driver software development application programming interface (API) provides a function called PsSetLoadImageNotifyRoutine. This function is used to specify the entry point of a callback, “ImageLoadCallbackFunction”. A “callback” (or “callback function”) is an executable code that is passed as a parameter to another function or code. The parameter may be called at a later point in time by any other function or code that has a valid reference to it. In this example, the callback function “ImageLoadCallbackFunction” is registered to be called (or invoked) by the operating system every time an executable image is loaded into virtual memory just prior to execution. This occurs when a new process (i.e. data destination) is created. The new process is the new data destination. Typically, the loading of an executable image with a name having the “.exe” extension indicates that a new process is created. The callback function may also be called at times other than during the creation of a new process. For example, the callback function is also invoked for the loading of dynamic link libraries (DLLs) for an existing process, that is, one that does not involve the creation of a new process.

The invocation of the internal function notifies the first processing module that a new data destination has been created 23. The notification further comprises information regarding the data destination. Referring to the previous example, for instance, the information may include the image name and an identifier (ID) of the process to which the image is mapped.

The first processing module may record the data destination information provided in the notification 24. This information can be recorded into a memory space of the computer on which the first processing module resides, or it may be stored into the computer's hard disk. The first processing module may also store the information in different data structures. In one embodiment, the data destination information is recorded in a list or array data structure. In some embodiments, the first processing module sends the name of the data destination, or other information regarding the data destination, to the controller or the second processing module. Based on the information sent, the controller may be triggered to automatically attach the second processing module to the data destination, or the second processing module may be triggered to automatically attach itself to the data destination.

In an embodiment comprising a controller, the controller retrieves the data destination information previously stored by the first processing module 25. Optionally, the controller also retrieves extra information about the data destination from the operating system 26. Examples of the extra information include: a starting memory address of the data destination's input handling functions, at least some of the instructions of the input handling functions, and the libraries or modules used by the input handling functions. The data destination information and the extra information may be recorded into a database within the controller.

In some embodiments, the controller searches its database to find a match for the retrieved data destination information, such as the name of the data destination. The database includes the types of data destinations that the current technology protects. Each entry of a data destination type may further be accompanied by the aforementioned extra information.

Based on the result of this match, the controller decides whether the second processing module will be attached to the front of the data destination's input handling functions 27. The decision may be set as a flag. For example, the flag indicates that there is no match, and that the current data destination will not be protected 28. The flag may indicate that there is a match, and that the data protection can be protected 29. The second processing module may generate a machine instruction according to the extra information associated with the data destination. The machine instruction is needed, so that the decryption functions of the second processing module may be attached to the front of the data destination go.

In one embodiment, the interception of input handling functions occurs immediately after the DLL of the second processing module is injected into the process address space of the data destination. Upon a “match”, as indicated by the flag, the controller injects the second processing module's DLL into the process address space of the data destination. After this injection, the second processing module intercepts the input handling functions. DLL injection is a technique for running codes in the address space of another process through a forced load of a dynamic link library. Other methods of running codes in another process space can be used instead of DLL injection.

In another embodiment, the flag is observable by the second processing module, where the second processing module is operating in the process address space of the data destination, but has not yet attached itself to the input handling functions. The second processing module can be made to operate in the process address space of the data destination through DLL injection. The DLL injection operation may be performed by a controller. In this embodiment, the DLL injection of the second processing module is performed for all processes, but whether the second processing module is attached to the data destination depends on the value of the flag.

A second processing module is attached in front of an input handling function of a data destination 31. The following paragraphs describe three different attachment methods that may be used. Other methods may be used, as long as the source code of the data destination is left unchanged. The attachment process occurs during runtime, and allows the second processing module to intercept the encrypted data, decrypt it, and pass the decrypted data to the input handling function. Preferably, the attachment process is “dynamic”, and may be enabled for only some selected data destinations, for all data destinations, or for none of the data destinations.

Referring to FIG. 3, the attachment may be achieved via “hooking” the second processing module to a front portion of an input handling function of the data destination. The hooking process includes the steps of (A) modifying the input handling function to call one or more functions in the second processing module, and (B) returning from one or more functions in the second processing module to the input handling function after the point where the second processing module is called.

Typically, in step A above, the first few bytes of machine code instructions 32 of the input handling function 33 are changed. The change 34 enables the input handling function 33 to call one or more functions in the second processing module 35. In one example, step B is performed via a ‘trampoline’ function. The second processing module function 35 that is called or invoked by the first few bytes 32 may call a trampoline function 36. From the trampoline function, the input handling function is re-entered at the point right after the call to the second processing module function 35.

Typically, before the input handling function 33 is modified, the original bytes of the input handling function that will be subsequently replaced are copied to the beginning of the trampoline function 36. A jump instruction back to the input handling function is then inserted after the copied original bytes 37. The jump location is the point right after the call to the one or more functions of the second processing module 35.

Therefore, after the second processing module functions 35 are executed, decryption is performed, and the processing flow returns to the input handling function 33. In this case, the second processing module calls the input handling function 33, using the decrypted input data 38 as the input parameter for the input handling function. Steps A or B may involve the use of a disassembler to determine the correct number of bytes of machine code instructions to modify.

In another embodiment, the input handling function is called from the second processing module function via the trampoline function before decryption is performed. In this scenario, decryption requires the use of data returned by the input handling function, which is why decryption occurs after the call to the input handling function. After the second processing module functions are executed, decryption is performed, and the processing flow returns to the caller of the modified input handling function.

In a Microsoft Windows operating system, the attachment may alternatively be achieved via subclassing. In cases where the data destinations are windows, the second processing module may be implemented with a window procedure. A window procedure is a subroutine that processes messages for a window. The window procedure allows the second processing modules to execute subclassing techniques, to intercept or process the input destined for the data destination.

In a Microsoft Windows operating system, the attachment may alternatively be achieved via hook procedures implemented in the second processing module. The second processing module may be installed in hook chains provided by the operation system. Each hook chain comprises a plurality of hook procedures of a particular type. A hook procedure is a subroutine that can receive, monitor, and in some cases modify a message before passing it to another hook procedure along the hook chain. The hook procedure belonging to the second processing module modifies the input data. The data becomes decrypted at the end of the second processing module's hook procedure, where the decrypted data is passed to the data destination.

In some embodiments, the second processing module may implement a combination of the hooking of input handling functions, windows subclassing, or hook procedure installation in hook chains, so as to be attached to the data destination.

### Operation of the Security System

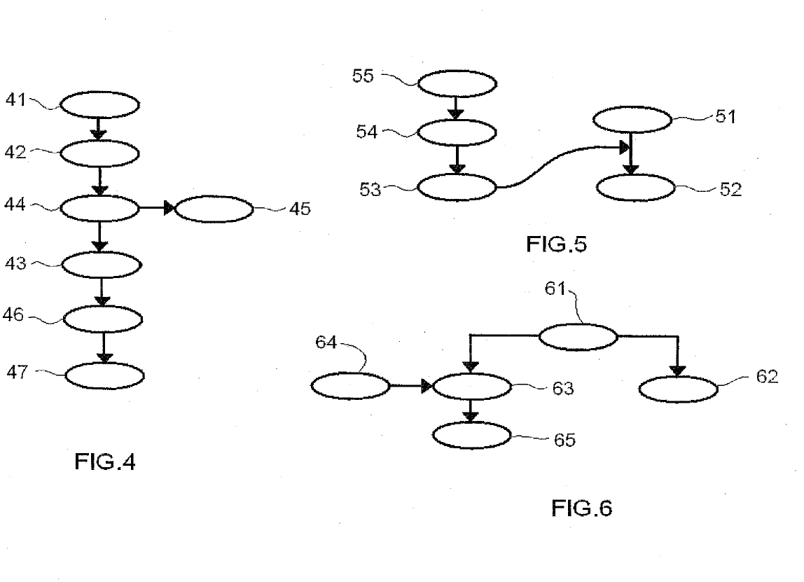

Referring to FIG. 4, a user interacts with the input device and input data is generated 41. Input data is encrypted by the first processing module to form encrypted input data 42. Encrypted input data is transmitted to the second processing module for a protected data destination 43. The data transmission may be done using the same communication channels as the one used for unencrypted input data 44. In one embodiment, the encrypted input data is transmitted by the operating system to the running application that has been protected by a method disclosed in this invention. Only the encrypted data is observable by any spyware applications attempting to monitor and steal data during the transmission 45. The encrypted input data received at the second processing module is decrypted to extract the original input data 46. The extracted input data is passed to the input handling functions of the data destination for processing 47.

### Data Encryption

Referring to FIG. 5, the encryption and decryption of data requires encryption and decryption keys. The keys may be generated using initialisation data. The initialisation data is generated 51 and then securely communicated between the modules of the security system 52. For example, the initialisation data may be generated and transmitted in one of the following ways:
(a) The first processing module generates the initialisation data and securely transmits the data to the second processing module.
(b) The second processing module generates the initialisation data and securely transmits the data to the first processing module.
(c) A third processing module generates the initialisation data and securely transmits the data to both the first and second processing modules. In one embodiment, the third processing module may be provided by a controller coupled to the first and second processing modules.

The transmission of initialisation data between the processing modules can be secured by encryption 53. For example, an Advanced Encryption Standard (AES) encryption algorithm can be used to encrypt the initialisation data. This assumes that the encryption key for the encryption and decryption of the initialisation data is exchanged securely 54. The encryption keys may be generated and exchanged using one or a combination of the following methods:
(a) Encryption keys are hard-coded into the first, second or third processing module
(b) Encryption keys are generated and exchanged on an occasional or regular basis. The key generation and exchange may be performed at regular time intervals, at each occurrence of a particular event internal to the computer, or at each occurrence of a particular external event
(c) Encryption keys are generated and exchanged on operating system start-up
(d) Encryption keys are generated and exchanged on start-up of an implementation of an embodiment of the present invention
(e) Encryption keys are generated and exchanged every time a non-active data destination, such as the background window of a running application, is made active. An example of making a non-active data destination active is bringing the window of a background running application to the foreground by the user.

The secure exchange of encryption keys between the processing modules may be carried out using some form of communication. For example, a second processing module operating in user-space generates a key. The key is communicated to the first processing module, a driver for the input device. The communication process makes use of a kernel to user space interface. For example, using an “input/output control” (ioctl) calls, the second processing module can communicate with the first processing module.

An encryption key may further be used as a master key to encrypt another encryption key, known as a session key 55. A session key has a shorter lifetime than a master key. For example, a master key may be generated and exchanged on operating system start-up. The master key is then used to encrypt and exchange session keys. The session keys may then be used to exchange initialisation data. It is possible for a malware application to deduce an encryption key, if the same key is used over a sufficient period of time. Therefore, the use of session keys lowers the likelihood for a malware application to learn the encryption key.

In one embodiment, the encryption process performed by the first processing module includes the use of one-time pad encryption. One-time pad encryption encrypts the real input data using a generated sequence of random keys. The sequence has the same length as the real input, and is never repeated. For example, the one-time pad encryption process may involve the use of a cryptographically strong random number generator, such as one based on the Blum Blum Shub algorithm. In this embodiment, the decryption process performed by the second processing module correspondingly involves one-time pad decryption. The one-time pad decryption uses a corresponding sequence to reverse the encryption performed by the first processing module.

In embodiments where the encryption process uses a cryptographically strong random number generator, the decryption process also uses a cryptographically strong random number generator. In the case of one-time pad encryption and decryption, the two random number generators are synchronised together, and produce the same sequence of random numbers. In practice, this embodiment means the two random number generators have to be initialised in the same way, using the same initialisation data. Initialisation data may include the initial seed for the random number generators.

### Switching Between Data Destinations

In some embodiments, a user of a computer system determines the set of data destinations to protect. For example, from the user interface, the user chooses to protect all data destinations. The user may also choose to exclude some data destinations.

In one embodiment, the present technology is installed on a computer running an operating system where the user interface includes desktops, windows and dialog boxes. One or more windows are typically associated with a running application. In this case, each window of the running application may be treated as a data destination. When a user activates a window by, for example, clicking on any part of the window using a mouse, the window comes to the foreground. The previously activated window is deactivated and goes to the background.

Referring to FIG. 6, when a user switches between windows that are within or between running applications and are protected by the present technology, the following steps may be carried out:
(i) On activating a first window in the background and on deactivating a second window in the foreground 61, the second processing module for the second window stops receiving data from the first processing module 62. Because the data distribution process is under the operating system's control, the second processing module is not required to perform extra steps to stop receiving data from the first processing module.
(ii) The first processing module and the second processing module for the first window agrees on a new initialisation data 63 using one of the above described methods. The new initialisation data may be generated using a random number generator. The new initialisation data may be further processed to meet security, randomness, or other mathematical characteristics required by the first and second processing modules 64.
(iii) The first processing module and the second processing module for the foreground first window are now ready to perform encryption and decryption on the input data as described above 65.

### Encryption for a Keystroke Input

In one embodiment of the present invention, the input source is a keyboard. The input data received by the first processing module are keystrokes. For example, keystroke data include a code that represents the keyboard key and a code that represent whether a key was pressed or released. The key press and release codes may be treated as different data symbols during encryption and decryption. For example, using one-time pad encryption and decryption, a different random value is used to encrypt the key press and release codes of a single press-release keystroke event for a particular key. The same random values are then used for decryption.

In another embodiment, the key press and release codes may be treated as a unit during encryption and decryption. For example, using one-time pad encryption and decryption, the same random value is used to encrypt the key press and release codes of a single press-release keystroke event for a particular key. Decryption then uses the same corresponding random values. The encryption/decryption random values are used for a single press-release keystroke event only for a particular key. For security reasons, the random values are not reused for other keystroke events unless the random values have been re-generated by the random number generator.

### Conceptual Model Embodiment

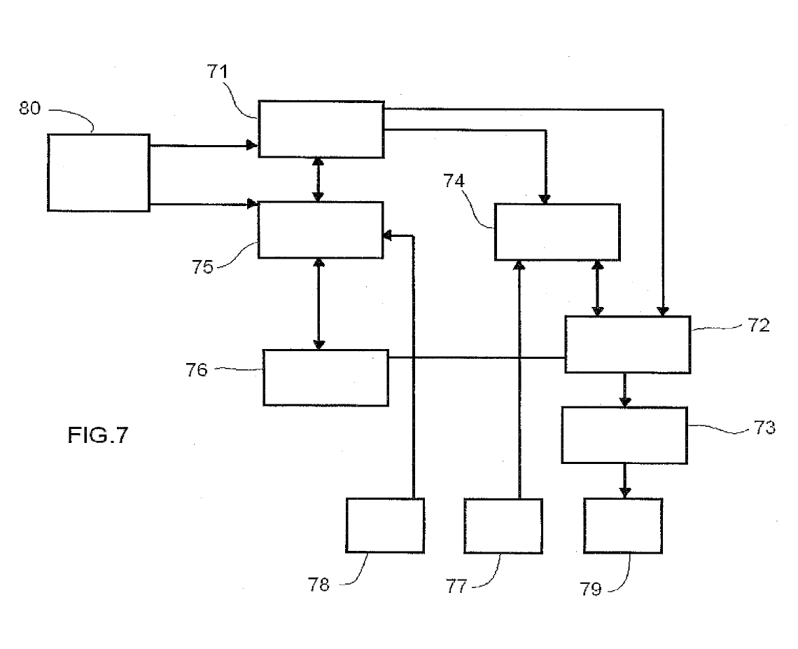

FIG. 7 is a conceptual model diagram of an embodiment of the present invention. The diagram illustrates the relationships between various modules and data elements of the embodiment. The arrows in the figure do not specifically indicate the flow of data or information. Instead, the arrows signify associations between objects.

As depicted, an input data protection system may protect any number of data destinations 76. The input data protection system comprises a controller 80, a first processing module 71 and any number of second processing modules 75. The operating system 72 comprises at least one input source driver 73. Input data from an input source 79 is read by the operating system 72 at the driver level using the corresponding input source driver 73.

The first processing module 71 interacts with and receives input data from the operating system 72. Typically, the first processing module 71 is installed as a device driver, such as a filter device driver that receives input data from the one or more input source drivers 73. The input source drivers 73 are typically provided with the installation of the operating system 72.

The first processing module 71 receives and processes the input data before the data is passed onto higher level operating system functions. The first processing module 71 receives the input data from the one or more input source drivers 73 and generates encrypted input data 74. The encrypted input data 74 is then passed to the operating system 72.

The operating system 72 distributes the encrypted input data 74 to other applications running on the operating system 72. Eventually, the encrypted input data 74 is passed on to a second processing module 75. Each second processing module 75 attaches or hooks onto a corresponding protected data destination 76. The second processing module 75 synchronises and exchanges data with the first processing module 71. For example, in an embodiment where the first and second processing modules implement one-time pad encryption to scramble the input data, initialisation data is encrypted and securely exchanged between the first and second processing modules. On receiving the encrypted input data 74, the second processing module 75 decrypts the encrypted input data and provides the decrypted input data to the data destination 76.

Any number of spyware applications 77 may also be running on the computer system. For example, spyware 77 attempts to spy on input data as it travels through the operating system 72 to the running applications. However, because the first processing module 71 encrypts the input data early in the processing chain, the data obtained by spyware 77 is a scrambled version of the input data, and therefore is not comprehensible to the attacker.

Any number of backdoor applications 78 may also be running on the computer system. For example, a backdoor may attempt to make use of the “netcat” application to enable a remote attacker to send commands to the computer system via a remote shell. The “netcat” application redirects standard input/output data between the shell program and the attacker over a communications network. In one exemplary use of the present invention, a protected data destination 76 may be the shell program targeted by a remote attacker. Here the attacker attempts to send remote commands to data destination 76 via the backdoor 78. However, the commands sent are first intercepted by second processing module 75, where the second processing module 75 will perform decryption on the data. Because the commands have not been encrypted by the first processing module 71, the result of the decryption process is a scrambled data that will not be interpreted correctly by the data destination 76 (the shell program). In this way, the attacker is unable to send commands and have them executed by the protected shell program.

In some embodiments, AES encryption is employed, and the encryption and decryption processes return to normal operation after scrambling an unauthorised command. In some embodiments, the encryption and decryption processes operate according to the same sequence of random keys. Therefore, once an attacker sends commands to the data destination 76, the second processing module 75 loses synchronisation with the first processing module 71. The user of the computer system may notice this loss of synchronisation through feedback of the “decrypted” input data. For example, in the case where the input source 79 is a keyboard, this feedback may be the display of text characters on the computer screen. At the loss of synchronisation, the “decrypted” input data will appear scrambled. A reset function may be provided to the user to re-establish synchronisation. At the same time, the user may be warned during reset that an attack may be taking place. In another embodiment, the loss of synchronisation is detected and re-established automatically.

The controller So is responsible for controlling the operations of the first and second processing modules. For example, it may control the synchronisation and reset of the first and second processing modules. The controller So may be implemented and installed in a computer as an executable file, a library such as a dynamic link library (DLL), or both.

### Data Flow

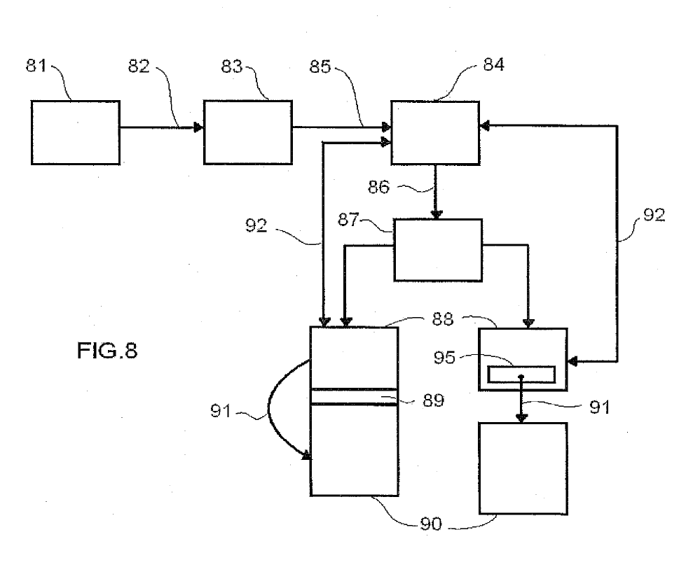

FIG. 8 illustrates the data flow of one embodiment of the present technology. A user interacts with input source 81 to produce a first input data 82. An operating system is usually distributed with a standard set of input source drivers 83. The first input data 82 is transmitted to the input source drivers 83. The input source drivers 83 process the first input data 82 to generate a second input data 85. The second input data 85 is transmitted to the first processing module 84. The first processing module 84 is preferably installed as early in the processing chain as possible. For example, the first processing module 84 may be a filter device driver installed on the Microsoft Windows operating system. The first processing module 84 encrypts the second input data 85 to generate the encrypted second input data 86. The encrypted second input data 86 is then passed to the operating system 87 for distribution to other parts of the operating system and to other running applications. The other running applications may or may not include spyware applications.

Typically, the distribution process is performed through normal communication channels of the operating system. These channels may include vulnerabilities that can be exploited by malware. The encrypted second input data 86 eventually arrives at the second processing module 88. The second processing module 88 may be, for example, installed using a hook 89 on the data destination go. The hook 89 may take the form of modified function calls as previously described. In some embodiments, the second processing module 88 may comprise a subclass window procedure 95. The subclass window procedure 95 intercepts the incoming data for the data destination go to decrypt it. The second processing module 88 then performs decryption on the encrypted second input data 86 to generate the decrypted second input data 91. The decrypted second input data 91 is then passed on to the data destination go. The second processing module 88 may also interact with the first processing module 84 to exchange initialisation data.

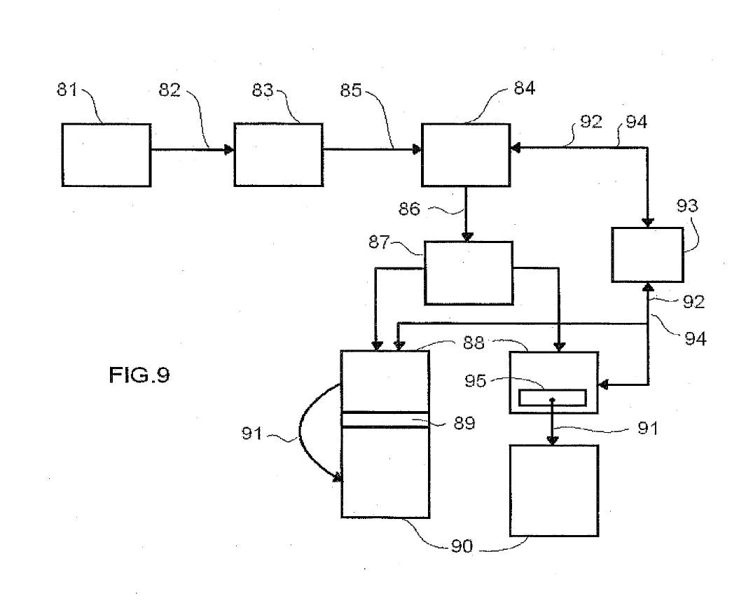

FIG. 9 illustrates the data flow of another embodiment of the present technology. This embodiment is similar to one shown in FIG. 8, with the exception that a controller 93 is introduced to control the operation of the first and second processing modules. The controller 93 may be used to transmit initialisation data 92 and control signals 94 such as resets, between the first and second processing modules.

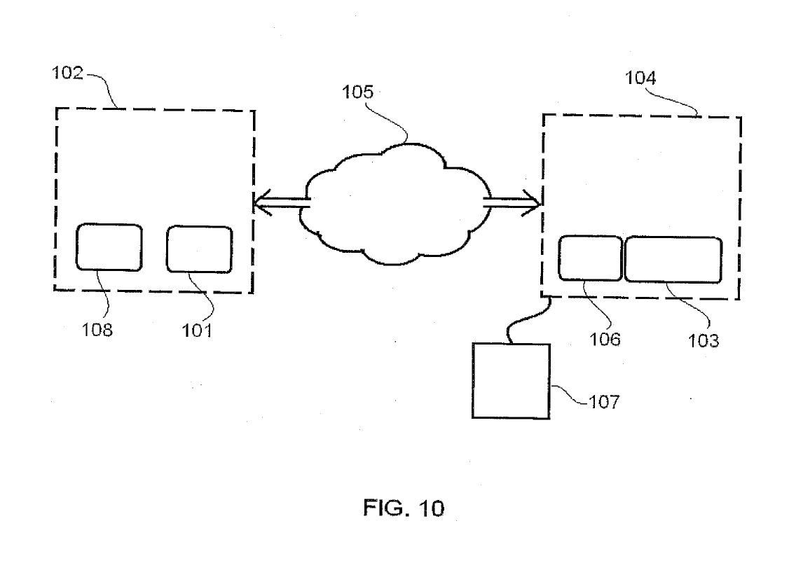

Referring to FIG. 10, in one embodiment of the present technology, the first and second processing modules are installed and executed on separate computer systems. The computer systems may be coupled via a network, such as a local area network (LAN) or the Internet.

For example, a first processing module 106 may be installed on a computer 104. An input device 107 is coupled to the computer 104. The first processing module 106 encrypts input data from input device 107. A second processing module 103 is active and attached to a particular data destination. The encrypted data generated by the first processing module 106 is transmitted to second processing module 103. The encrypted data may also be transmitted over a network 105 to another second processing module 101 provided by another computer 102. The other second processing module 101 operates in a similar manner to the second processing module 103 provided in the first computer 104, and is capable of decrypting the encrypted data generated by the first processing module 106. An optional controller 108 may also reside on the other computer 102. The controller 108 may decide and control when and if data from the first processing module 106 is transmitted to the other second processing module 101 via network 105. The controller 108 may also assist in performing the initialisations and synchronisations required for the correct operation of the first processing module 106 and the other second processing module 101. This embodiment may be useful if input data from input device 107 needs to be transmitted securely to the other computer 102.

The applicant envisages that the technology will have a wide range of applications, for example, for use in securing: user inputs into Internet chat applications; the typing of e-mails; the creation of text documents; the entering of usernames and passwords; the input of credit card details; and the input other sensitive information. The present technology is also applicable in securing the input of mouse movements and button presses, and the input of user data using other physical devices. This invention is also applicable to protecting users from backdoor attacks that exploit the input of mouse movements and button presses, and the input of user data using other physical devices.

The reference to any prior art in this specification is not, and should not be taken as, an acknowledgment or any form of suggestion that that prior art forms part of the common general knowledge

While the present invention has been described with reference to particular details of construction, these should be understood as having been provided by way of example and not as limitations to the scope or spirit of the invention.

What is claimed is:

1. A computer readable medium having stored therein computer programs, comprising:
a first processing module for performing an encryption on an input data from an input device;
a second processing module comprising internal functions that are attachable to a data destination;
the internal functions adapted to intercept a data for the data destination and perform a decryption on the data, the decryption corresponding to the encryption.

2. The computer readable medium of claim 1, wherein,
an attachment of the second processing module's internal functions to the data destination is achieved using a hooking process.

3. The computer readable medium of claim 1, wherein,
the first processing module is a driver for processing the input data.

4. The computer readable medium of claim 1, wherein,
the first processing module causes an operating system on which the computer readable medium is installed to call a function of the first processing module, while the operating system generates a new data destination.

5. The computer readable medium claim 1, wherein,
the second processing module comprises at least an executable file or a library.

6. The computer readable medium of claim 1, further comprising,
a third processing module that generates an initialization data.

7. The computer readable medium of claim 6, wherein,
a transmission of the initialization data between any two processing modules is encrypted.

8. The computer readable medium of claim 6, wherein,
the third processing module is provided by a controller that is coupled to the first and second processing modules.

9. The computer readable medium of claim 1, wherein,
the first processing module resides on a first computer that is coupled to a second computer via a network, wherein the second computer comprises a second processing module capable of decrypting an encrypted data generated by the first processing module.

10. The computer readable medium of claim 9, wherein,
the second computer is a server of a network, and the first computer is a client computer of the network, wherein an administer of the network distributes the first processing module to the client computer.

11. An apparatus that mitigates against a malware attack, comprising:
a first processing module installed on a computer having an input device; the input device generating an input data;
the first processing module performing an encryption on the input data; a second processing module for performing a decryption;
the second processing module being adapted to intercept and decrypt a data being transmitted to a data destination.

12. The apparatus of claim 11, wherein,
the first processing module is a driver for the input device.

13. The apparatus of claim ii, wherein,
an initialization data used by both the first and second processing modules is encrypted using a session key, the session key being encrypted using a master key.

14. The apparatus of claim 13, wherein,
the master key is generated at a start-up of the apparatus, and the session key has a shorter life time than the master key.

15. The apparatus of claim 11, further comprising,
a controller that decides whether the second processing module performs decryption on the data being transmitted to the data destination.

16. The apparatus of claim 15, wherein
the controller comprises a data destination database, and the controller cross-checks a information about the data destination with the database, wherein the second processing module decrypts the data if a match is found.

17. The apparatus of claim 15, wherein,
the controller further comprises a user interface, the interface allowing a user to reset an initialisation data used for the encryption.

18. The apparatus of claim ii, wherein,
an initialisation data used for the encryption is in synchronisation with an initialisation data used for the decryption, wherein the decryption of an unencrypted data causes a loss of the synchronisation.

19. The apparatus of claim 11, wherein,
the input device is a keyboard, and the input data comprises a code that represents a keyboard key and a code that represents the key's release or pressed state

20. The apparatus of claim 11, wherein,
the first processing module receives an input that is a movement of a computer mouse.

21. The apparatus claim 11, further comprising,
another second processing module, the other second processing module being attached to a front of a second data destination.

22. A method of protecting a computer against malware, comprising the steps of:
installing into a memory of the computer, a first processing module and enabling the first processing module to receive an input data from an input device;
employing a data encryption within the first processing module;
registering the first processing module to receive a signal from an operating system that generates a data destination;
recording a data destination information when the signal is received;
employing a data decryption within a second processing module; and
attaching the second processing module to a front of the data destination.

23. The method of claim 22, wherein,
the attaching does not require a change to a source code of the data destination.

24. The method of claim 22, further comprising,
synchronizing the data decryption and the data encryption by using a same initialization data for the first and the second processing modules.

25. The method of claim 22, further comprising,
installing into the memory a controller that stores the data destination information.
